(19) United States
(12) Patent Application Publication
(10) Pub. No.: US 2011/0314710 A1
(43) Pub. Date: Dec. 29, 2011

(54) DRIVER LEVEL INDICATION METHOD AND SYSTEM, AND DRIVER LEVEL INDICATOR

(76) Inventor: Daniel A. Luberto, Revere, MA (US)

(21) Appl. No.: 13/168,633

(22) Filed: Jun. 24, 2011

Related U.S. Application Data
(63) Continuation-in-part of application No. 29/376,065, filed on Oct. 1, 2010.
Application No. 29/376,065 is a continuation-in-part of application No. 29/376,069, filed on Oct. 1, 2010.
(60) Provisional application No. 61/334,150, filed on Jun. 24, 2010.

(51) Int. Cl. G09F 21/04; G09B 9/04; B60R 13/10

(52) U.S. Cl. 40/200; 40/591; 434/65

(57) ABSTRACT

A system and method for providing a driving or driver level indicator for a given driver are provided, as well as the driver level indicator. The driver level indicator can indicate a level of driver experience, inexperience, competency, or status of the driver, and can be presented or displayed at or in a vehicle operated by the driver, to alert or inform other drivers as to the level of driver experience, inexperience, competency, or status of the driver operating the vehicle.

### CROSS REFERENCE TO RELATED APPLICATIONS

This application claims the benefit of priority under 35 U.S.C. §119(e) from provisional application Ser. No. 61/334,150, entitled Notification sticker for all new drivers, filed on Jun. 24, 2010, which is incorporated herein by reference in its entirety.

The present application also claims the benefit of priority under 35 U.S.C. §120, as a continuation-in-part of U.S. design patent application 29/376,065, filed Oct. 1, 2010, entitled Vehicle-Affixable Driver Level Indicator, and as a continuation-in-part of U.S. design patent application 29/376,069, filed Oct. 1, 2010, entitled Vehicle-Affixable Driver Level Indicator, each of which is incorporated herein by reference in its entirety.

### FIELD OF INTEREST

The present inventive concepts relate to the field of transportation, and more particularly to the field of automotive transportation and driver safety and courtesy.

### BACKGROUND

Despite the varying levels of driver experience and competency, drivers on busy roadways have no way of telling the experience or competency level of another driver, e.g., whether a driver has a Learner's Permit, is newly licensed, or is an elder driver. The tendency is for drivers to assume that other drivers are experienced and fully competent and, therefore, the assumption is that the driving behavior of others is predictable and safe. Such assumptions, while understandable, are not always valid, since inevitably inexperienced drivers and elder drivers, as examples, will be mixed in traffic with other drivers.

In challenging situations, such as where vehicles move at high rates of speed, operate in inclement weather, navigate busy intersections, merge on/off busy roads or highways, and the like, an inexperienced driver, as an example, may be naturally more prone to error or, at the very least, hesitation—which could prove dangerous for all drivers in the immediate vicinity. The same could be true for some elder drivers.

Errors or hesitation by inexperienced drivers or elder drivers can be extremely frustrating for other unsuspecting drivers, leading to horn blowing, and even road rage. Such aggressive behavior can be unnerving to an inexperienced or elder driver, and add to the likelihood of more errors or hesitation.

With new drivers, particularly teenagers, there is a progression for sanctioned permission to operate a vehicle on public roads. For example, according to the law in the Commonwealth of Massachusetts, a teenager can obtain a Learner's Permit as young as 16 years old, by passing an examination administered by the Registry of Motor Vehicles (RMV). At the age of 16½, a teen can get a Junior Operator License (JOL), with certain driving instruction requirements having been met. There are significant restrictions placed on those drivers having a JOL, and they are subject to enhanced penalties for violations of the law. A driver ceases to be a “junior operator” at the age of 18, and is then considered to be “fully licensed,” although “enhanced penalties” still apply until the age of 21. This is referred to as a “graduated license law.”

Statistics show that motor vehicle crashes are the number one killer of teens in the nation. New drivers are four times more likely to be killed and 14 times more likely to be injured than any other group. It would be advantageous, and greatly increase public safety, if there were an indication of a driving level of certain drivers, such as inexperienced drivers and elder drivers.

### SUMMARY

The present invention provides an apparatus and method for providing an indication of a driving or driver level for a driver, which can be presented at the vehicle being operated by the driver. As examples, the driver level indicator can indicate a level of driver experience, inexperience, competency, or status, such as with junior operators and elder drivers.

In accordance with one aspect of the present invention, provided is a computer-implemented method of determining a driver level and indicating a driver level at a vehicle. The computer can include one or more processors coupled to at least one non-transitory computer storage medium, e.g., a data storage device, subsystem or system. The method includes, using the computer, establishing at least one set of driver level criteria; determining if a driver meets a set of the driver level criteria, and, if so, issuing a corresponding driver level indicator.

The method can further include coupling the driver level indicator to a vehicle to be operated by the driver.

The at least one set of driver level criteria can include a driver age.

The at least one set of driver level criteria can define at least one driver experience level.

The at least one set of driver level criteria can define at least one driver safety level.

The at least one set of driver level criteria can include a set of driver level criteria indicating that the driver has a Learner's Permit.

The at least one set of driver level criteria can include a set of driver level criteria indicating that the driver is a junior operator.

The at least one set of driver level criteria can include a set of driver level criteria indicating that the driver is an elder driver. An elder driver can be a driver of at least 75 years of age.

The method can include coupling the driver level indicator to a vehicle window.

The method can include coupling the driver level indicator to a vehicle body part. The vehicle body part could be a bumper.

The method can include coupling the driver level indicator to a vehicle license plate.

The method can include coupling the driver level indicator to a vehicle mirror.

The method can include coupling the driver level indicator to a vehicle antenna.

The driver level indicator could be an adhesive decal, and the method could include sticking the decal to the vehicle.

The driver level indicator could be magnetic, and the method could include magnetically adhering the driver level indicator to the vehicle.

The driver level indicator could be or include a light or display, and the method could include displaying the driver level indicator light or display from the vehicle.

The driver level indicator could be a sign, and the method could include displaying the driver level indicator sign from the vehicle.

In accordance with another aspect of the present invention, provided is a driver level determination system. The system includes one or more processors coupled to at least one non-transitory computer storage medium, e.g., a data storage device, subsystem or system, at least one input device and at least one output device. At least one set of driver level criteria is stored in the computer storage medium. A driver level evaluation module, executable by the at least one processor, is configured to determine if a driver meets a set of driver level criteria, by processing driver data against one or more sets of driver level criteria.

The at least one set of driver level criteria can include a driver age and the driver data can include the driver's age.

The at least one set of driver level criteria can define at least one driver experience level. And the driver data can include a number of years the driver has been licensed to operate a vehicle.

The at least one set of driver level criteria can define at least one driver safety level. And the driver data can include a number of accidents, traffic violations, or both of the driver.

The at least one set of driver level criteria can include a set of driver level criteria indicating whether the driver has a Learner's Permit.

The at least one set of driver level criteria can include a set of driver level criteria indicating whether the driver is a junior operator.

The at least one set of driver level criteria can include a set of driver level criteria indicating whether the driver is an elder driver. An elder driver can be a driver of at least 75 years of age.

The at least one output device can generate an output indicating assignment of a driver level indicator to the driver based on a determination that the driver data satisfied a corresponding set of driver level criteria.

The driver level indicator could be an adhesive decal configured to be adhered to a vehicle.

The driver level indicator could be magnetic and configured to be magnetically adhered to a vehicle.

The driver level indicator could be a light or display configured to be displayed from a vehicle.

The driver level indicator could be a sign configured to be displayed from a vehicle.

The driver level indicator could be configured to couple to a vehicle window.

The driver level indicator could be configured to couple to a vehicle body part. The vehicle body part could be a bumper.

The driver level indicator could be configured to couple to a vehicle license plate.

The driver level indicator could be configured to couple to a vehicle mirror.

The driver level indicator could be configured to couple to a vehicle antenna.

In accordance with one aspect of the present invention, provided is a driver level indicator configured to couple to a vehicle. The driver level indicator includes: a substrate configured to present a driver level for a driver, wherein the driver level is based on satisfaction of a set of predefined driver level criteria by driver data of the driver; and an attachment mechanism configured to attach the substrate to a vehicle in a manner that the driver level is viewable by other drivers.

The driver level indicator can indicate an experience level of the driver.

The at least one set of driver level criteria can include a set of driver level criteria indicating that the driver is a junior operator.

The driver level indicator can include the text “Learner's Permit.”

The driver level indicator can include the text “Beginner Driver” or “Beginner.”

The driver level indicator can include the text “Junior Operator.”

The driver level indicator can include the text “Elder Driver.” An elder driver can be a driver of at least 75 years of age.

The driver level indicator can be removably attachable to the vehicle.

There may be a plurality of driver level indicators, each driver level indicator indicating a different driver level.

Each of the plurality of driver level indicators may indicate a different driving experience level.

Each of the plurality of driver level indicators may indicate a different driving safety level.

The driver level indicator can take the form of a sign, flag, plaque, medallion, or decal.

The driver level indicator attachment mechanism can include an adhesive.

The driver level indicator attachment mechanism can include a magnet.

The driver level indicator attachment mechanism can include suction cups.

The driver level indicator can take the form of a display or light.

The driver level indicator can take the form of a license plate, license plate appendage, or license plate frame.

The substrate can include a plurality of colors.

In accordance with another aspect of the invention, provided is a plurality of driver level indicators, each configured to couple to a vehicle. And each driver level indicator includes a substrate including a driver level for a driver, wherein the driver level is based on satisfaction of a set of predefined driver level criteria by driver data of the driver; and an attachment mechanism configured to attach the substrate to a vehicle in a manner that the driver level is viewable by other drivers. Each driver level indicator corresponds to a different set of driver level criteria and has a different visual appearance.

In the various forms of the invention, the vehicle can be a car. In other forms, the vehicle may be a motorcycle, boat or commercial vehicle (e.g., a bus, train, freight truck, etc.). In other forms, the vehicle may be a piece of commercial equipment (e.g., backhoe, pallet truck, etc.).

Any of the driver level indicators above could be reflective.

Any of the driver level indicators above could include an audible output mechanism.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1A is a flowchart depicting an embodiment of a method of indicating a driver level at a vehicle, in accordance with aspects of the invention;

FIG. 1B is an embodiment of a driver level determination system, as a computer system that can be used to implement the method of FIG. 1A, in accordance with aspects of the invention;

FIG. 1C is an embodiment of a driver level indicator functional block diagram or computer architecture, in accordance with aspects of the present invention;

FIGS. 2A-D are front views of a first embodiment of different types of vehicle-affixable driver level indicators, in accordance with aspects of the present invention;

FIG. 3A-D is a front view of a second embodiment of different types of vehicle-affixable driver level indicators, in accordance with aspects of the present invention;

FIG. 4A-D is a front view of a third embodiment of different types of vehicle-affixable driver level indicators, in accordance with aspects of the present invention;

FIG. 5A-D is a front view of a fourth embodiment of different types of vehicle-affixable driver level indicators, in accordance with aspects of the present invention;

FIG. 6A-D are elevation views of the vehicle-affixable driver level indicators of FIG. 3A-D, respectively, attached to a rear window of an automobile;

FIG. 7A-D are elevation views of the vehicle-affixable driver level indicators of FIG. 3A-D, respectively, attached to a rear bumper of an automobile;

FIG. 8A-D are elevation views of the vehicle-affixable driver level indicators of FIG. 5A-D, respectively, attached to a rear body portion of an automobile; and

FIG. 9A-D are elevation views of the vehicle-affixable driver level indicators of FIG. 5A-D, respectively, attached to a rear window of an automobile;

FIG. 10A-D are elevation views of the vehicle-affixable driver level indicators of FIG. 5A-D, respectively, attached to a license plate of a vehicle;

FIG. 11A-D is a front view of a fifth embodiment of a vehicle-affixable driver level indicator, in accordance with the present invention;

FIG. 12A-D is a front view of a sixth embodiment of a vehicle-affixable driver level indicator, in accordance with the present invention;

FIG. 13A-D is a front view of a seventh embodiment of a vehicle-affixable driver level indicator, in accordance with the present invention;

FIG. 14A-D is a front view of a vehicle-affixable driver level indicator decal, in accordance with the present invention.

### DETAILED DESCRIPTION OF PREFERRED EMBODIMENTS

Hereinafter, aspects of the present invention will be described by explaining illustrative embodiments in accordance therewith, with reference to the attached drawings. While describing these embodiments, detailed descriptions of well-known items, functions, or configurations are typically omitted for conciseness.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

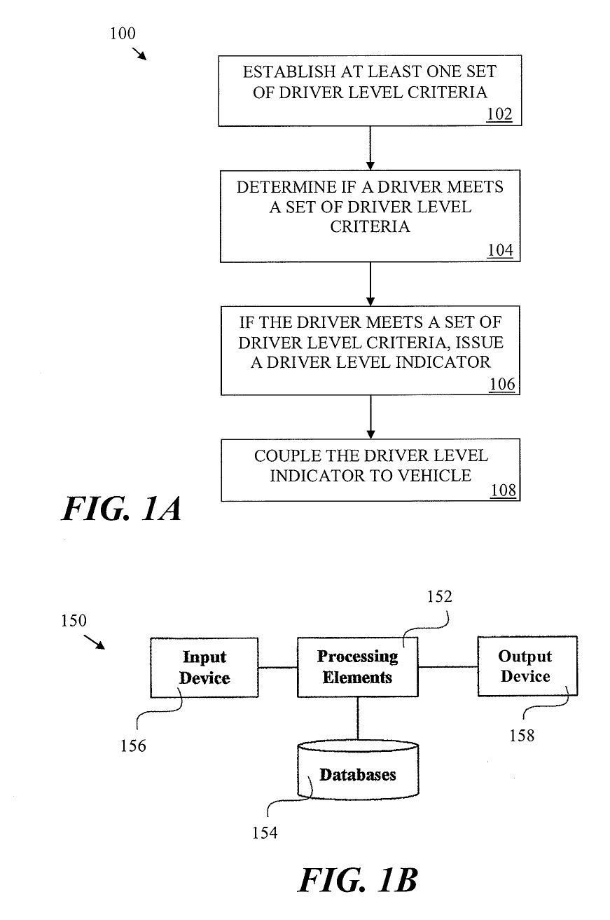

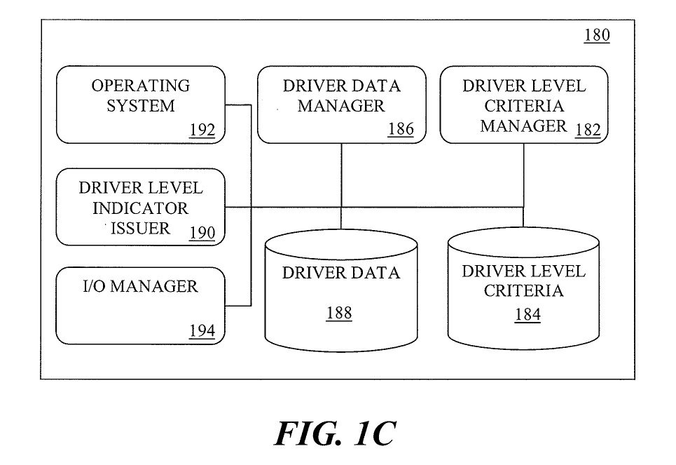

FIG. 1A depicts an embodiment of a method 100 for determining and issuing a driver level indicator for a vehicle driver or operator. FIG. 1B is an embodiment of a computer system 150 that can be used to implement method 100 of FIG. 1A.

The embodiment of FIG. 1B is of a simplified computer system 150, which includes at least one processing element or processor 152, which is configured to execute program code stored in storage system 154 to perform method 100 of FIG. 1A. At least one input device 156 may be used to prompt computer 150 to function, receive driver data, and define, receive, and/or generate driver level criteria, as examples. At least one output device 158 may be used to display, print, transmit, or otherwise output, driver level criteria, driver data, information or data prompts, and/or driver level indicators or driver level indicator issuance indicia (e.g., a form or electronic message indicating a driver should be issued a particular driver level indicator).

Referring to FIG. 1A, in step 102, at least one set of driver level criteria is established and stored in storage device or database 154. In step 104, the method includes determining if a driver (or driver data) meets a set of driver level criteria. In step 106, if the driver data meets a set of driver level criteria, a driver level indicator is determined or issued for the driver. In step 108, the driver can couple the driver level indicator to a vehicle to be operated.

FIG. 1C is an embodiment of a driver level indicator functional block diagram or computer architecture 180, which can be a representation of at least part of the driver level indicator computer system 150 of FIG. 1B. The functional block diagram or computer architecture 180 can include a variety of functional modules that can be implemented to perform method 100 of FIG. 1A. In this diagram, an operating system 192 and an input/output module 194 are included, as would be understood by those skilled in the art. Various modules or managers in FIG. 1C may be embodied in computer program code stored in a non-transitory medium (e.g., hard drive, computer chip memory, or the like) and executable by at least one computer processor (e.g., a micro-processor). Otherwise, the various modules and managers could be embodied in firmware or hardware. Otherwise, the various modules and managers could be implemented in a combination of the foregoing, or in or by similar devices.

A driver level criteria manager 182 may be included to help store and maintain driver level criteria in a driver level criteria database 184, which may be stored in or form part of storage device or database 154 of FIG. 1B. A driver data manager 186 may be included to help store and maintain information and/or data for a specific driver in a driver data database 188, which may be stored in or form part of storage device or database 154 of FIG. 1B. A driver level indicator issuer 190 may be included to apply driver level criteria to driver data to determine if the driver should be issued a driver level indicator. If there is more than one set of driver level criteria and indicators, the driver level indicator issuer 190 determines which, if any, of the driver level indicators should be issued to the driver.

In various embodiments, the driver level indicator is configured such that it can be attached or coupled to a vehicle to be operated by the driver. In the preferred embodiment, the driver level indicator is transportable between vehicles, so that it can be used in any vehicle to be operated by the driver for which it was issued. In some embodiments, the driver level indicator is configured to be removably attached, affixed, or coupled to, or displayed from, the vehicle. In some embodiments, the driver level indicator can be disposed relatively irremovably on or in the vehicle, e.g., by a permanent adhesive, screws, rivets, or other relatively irremovable securing mechanism.

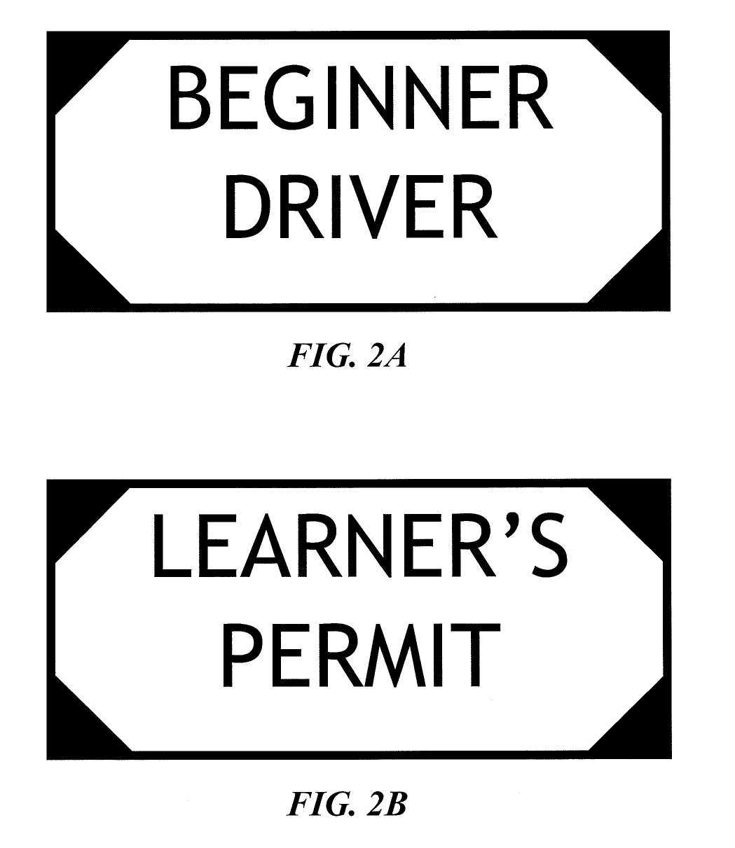

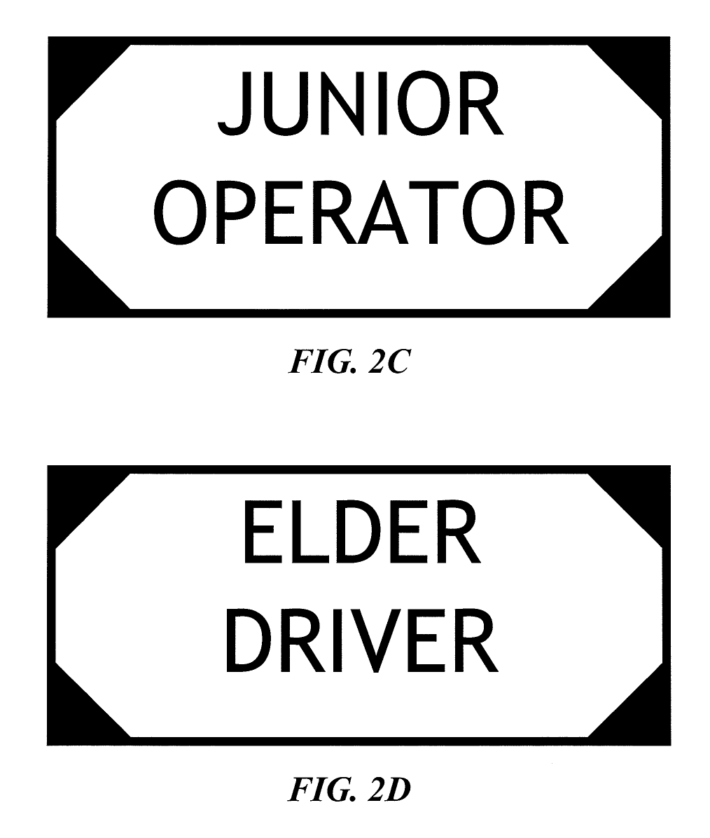

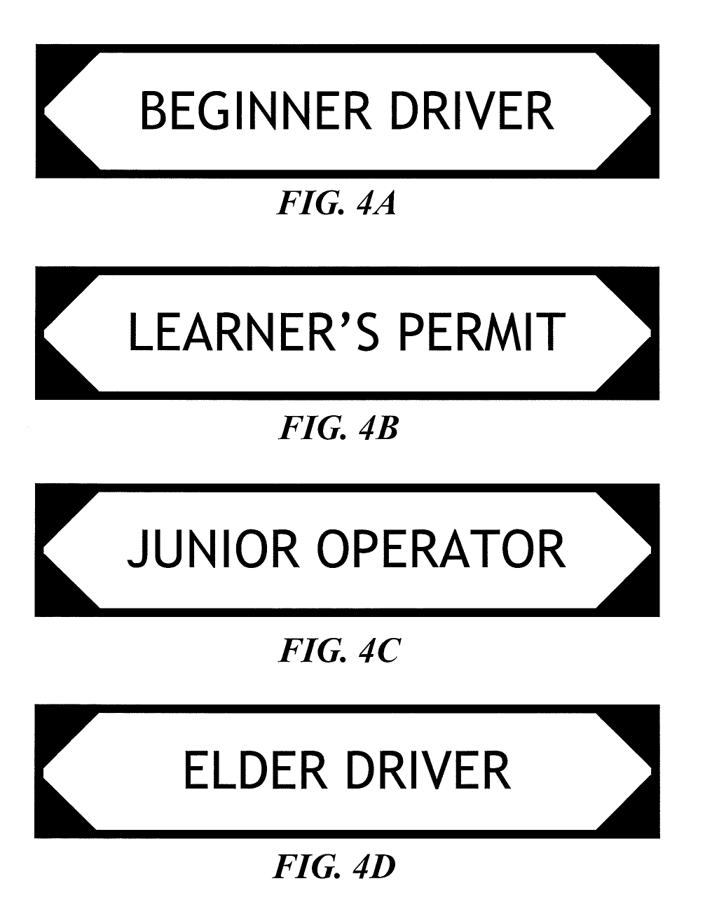

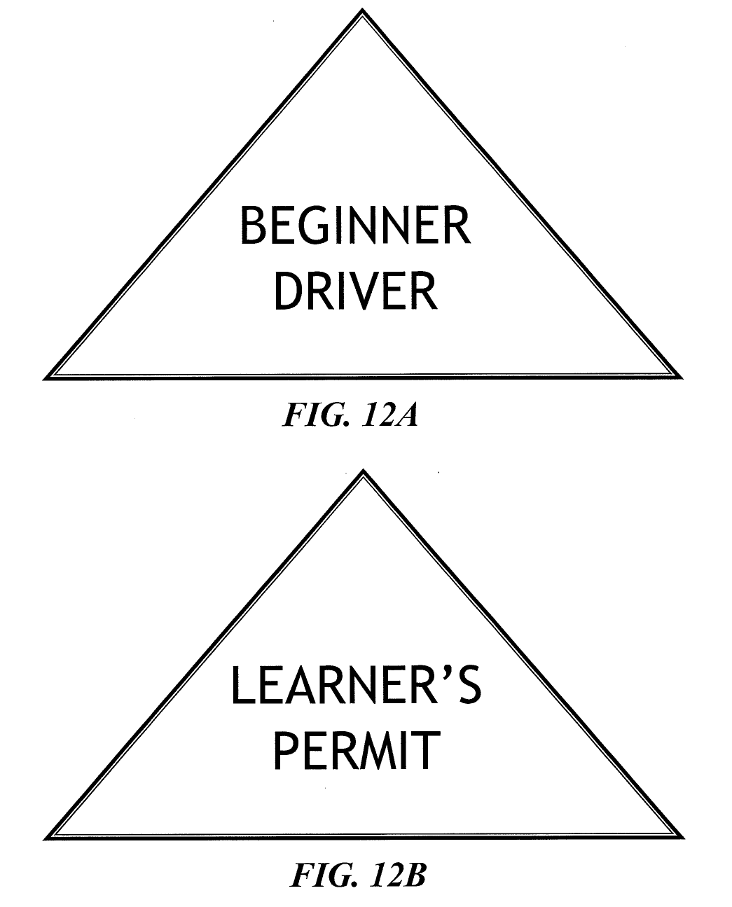

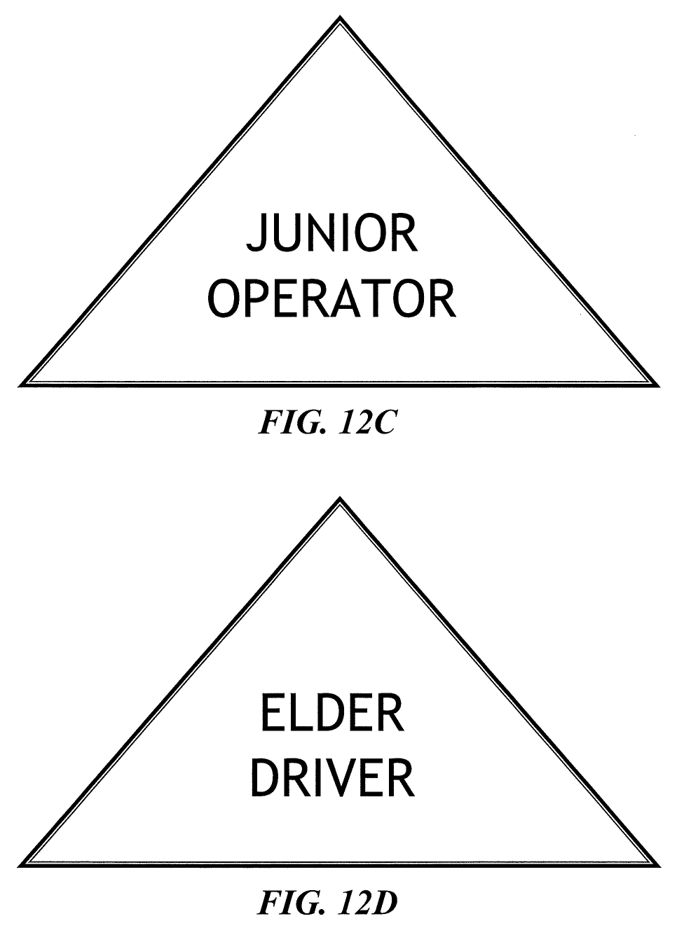

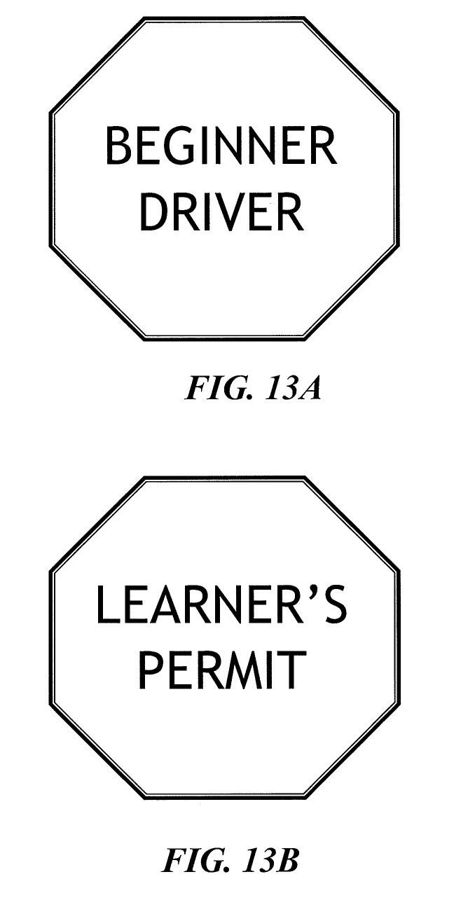

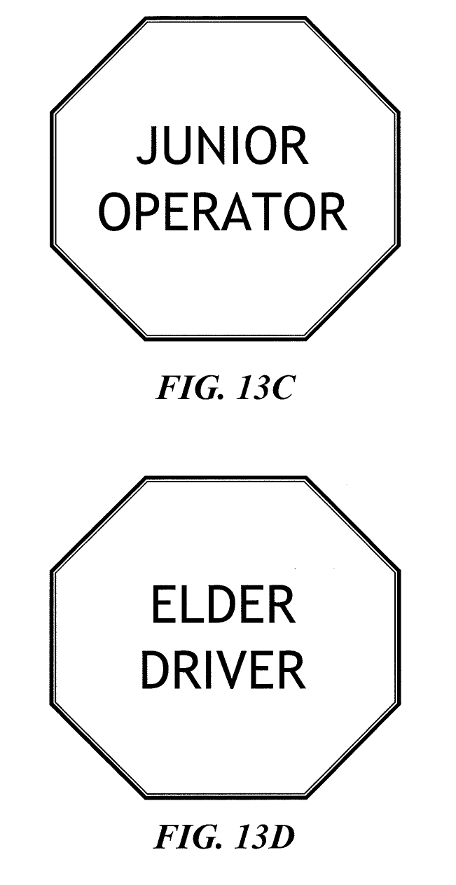

FIGS. 2A through 14D show different embodiments of a driver (or driving) level indicator in accordance with aspects of the present invention. In these embodiments, the driver level is provided via a substrate (e.g., paper, plastic, display, etc.) that can be attached to a vehicle via an attachment mechanism (e.g., glue, screws, magnet, suction cups, etc.), such that the driver level is viewable or visible to other drivers in the immediate vicinity, e.g., in traffic.

In some embodiments, there may be a plurality of driver level criteria and indicators, and each of the driver level indicators can indicate a different driver level.

In some embodiments, the driver level indicator can indicate a safety level of the driver. The safety level can be indicative of a number or frequency of accidents, a number or frequency of traffic violations, such as speeding violations, driving while intoxicated, and the like, or both for a given driver—which can form driver level criteria.

In some embodiments, the driver level indicator can indicate an experience or inexperience level of the driver. For example, in some embodiments, a set of driver level criteria can indicate whether or not a driver has a learner's permit, is a junior operator, or is generally a beginner driver. In some embodiments, the driver level indicator can include or display the words “Beginner Driver” or “Beginner,” “Learner's Permit,” “Junior Operator,” or the like—as in FIGS. 2A-C through 14A-C, respectively.

In some embodiments, the driver level indicator can indicate if a driver is at or above a certain age. In such cases, the driver level indicator can include or display the words “Elder Driver,” or the like. An elder driver can be, as an example, a driver of at least 75 years of age—as in FIGS. 2D through 14D.

In each of the sets of FIGS. 2A-D through 14A-D, the “A” figure is for a driver level indicator with the text “Beginner Driver;” the “B” figure is for a driver level indicator with the text “Learner's Permit;” the “C” figure is for a driver level indicator with the text “Junior Operator,” and the “D” figure is for a driver level indicator with the text “Elder Driver.” These are provided by way of example, and not by way of limitation.

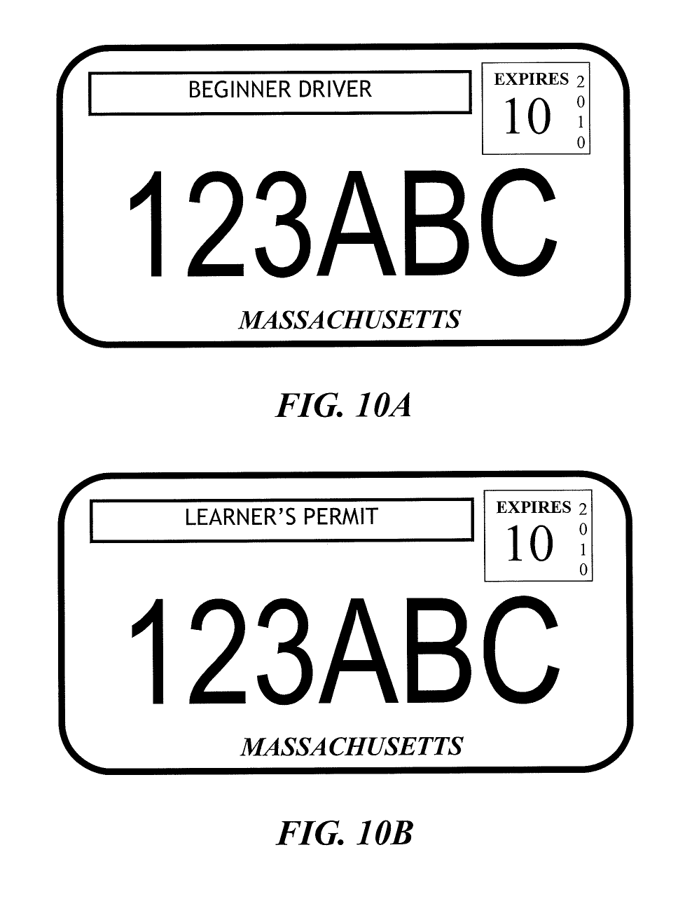

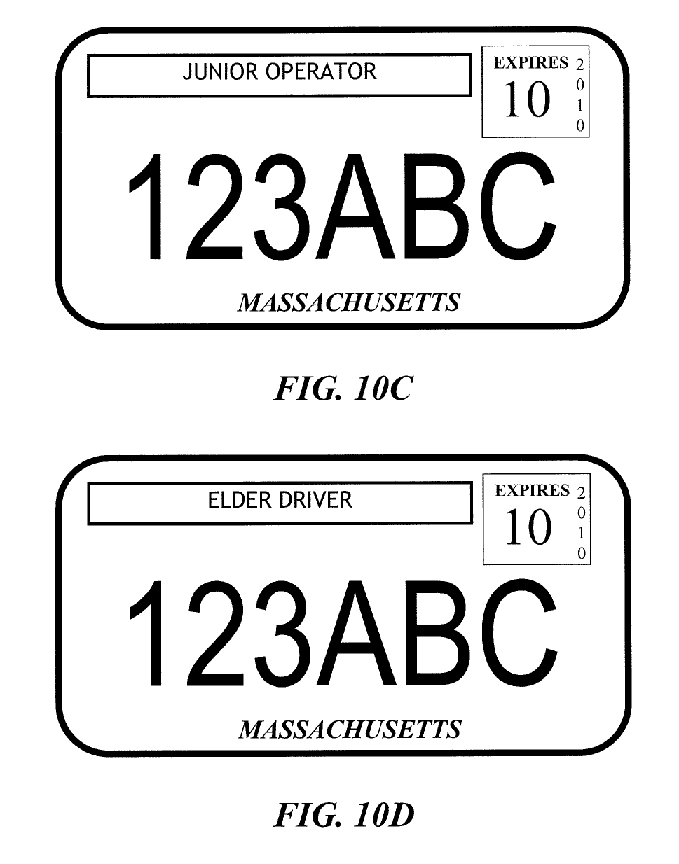

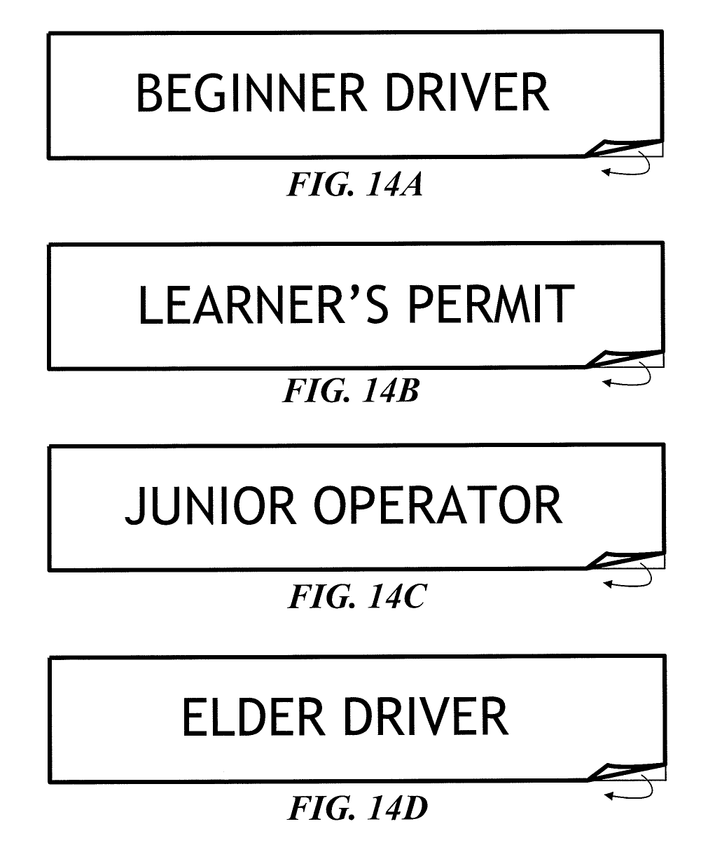

In various embodiments, the driver level indicator takes the form of a sign, flag, plaque, medallion, or decal. In some embodiments, the driver level indicator can be adhesive or magnetic, as in FIGS. 2A-D through 14A-D. In the embodiments of FIG. 14A-D, the driver level decal is a peel and stick decal (or sticker)—as an example. In some embodiments, the driver level indicator can take the form of a license plate, license plate appendage, or license plate frame, as in FIGS. 10A-D. In other embodiments, the driver level indicator can take the form of a light or display, which could look like any of FIGS. 2A-D through 13A-D, or present the same or similar text.

In the example embodiment, method 100 of FIG. 1A is directed to inexperienced drivers. At least two levels of inexperience can be defined and a set of inexperience level criteria can be defined for each. As an example, a first level can be for driver's operating with a “Learner's Permit.” In some jurisdictions, new drivers of a certain age operate under a learner's permit for a predetermined period of time, e.g., 6 months. A second inexperience level can be for newly licensed drivers, e.g., a driver just having his or her license issued. These drivers can be referred to as “Junior Operators” or “Beginner Drivers.”

The criteria for each level can be defined in accordance with the driver laws of the particular jurisdiction. But factors such as driver age and completion of driver training can be criteria. For example, the driver level criteria for issuance of a “Learner's Permit” driver level indicator can be the same used by the registry or department of motor vehicles for the particular jurisdiction for issuing a Leaner's Permit. In such a case, satisfaction of the criteria for obtaining a Learner's Permit can prompt issuance of a “Learner's Permit” driver level indicator.

As another example, the driver level criteria for issuance of a “Junior Operator” driver level indicator can be the same used by the registry or department of motor vehicles for the particular jurisdiction for issuing a Junior Operator License. In such a case, satisfaction of the criteria for obtaining a Junior Operator License can prompt issuance of a “Junior Operator” driver level indicator.

As another example, the driver level criteria for issuance of a “Beginner Driver” driver level indicator can be the same used by the registry or department of motor vehicles for the particular jurisdiction for issuing a Junior Operator License. In such a case, satisfaction of the criteria for obtaining a Junior Operator License can prompt issuance of a “Beginner Driver” driver level indicator.

As another example, the driver level criteria for issuance of a “Beginner Driver” driver level indicator can be the same used by the registry or department of motor vehicles for the particular jurisdiction for defining the phase between issuing a Junior Operator License and a next driver status, for example, reaching age 21. In such a case, satisfaction of the criteria for obtaining a Junior Operator License and being at least first age, for example, age 18, without being over a second age, for example age 21, can prompt issuance of a “Beginner Driver” driver level indicator.

The present invention is described with respect to driver experience, inexperience, status, or competency level, which could include indicating an experience, inexperience, or competency level as, for example, a novice driver, a proficient driver, and an advanced driver (relatively “clean” driving record).

For example, a novice driver can be a driver with a learner's permit, junior operator license, or otherwise newly licensed (or licensed for less than a predetermined time), an accident or violation prone driver, or the like.

For example, a proficient driver could be a driver with more experience than a novice driver and/or relatively few accidents and/or driving violations.

For example, an advanced driver could be a driver with more experience than a novice driver (or a proficient driver) and/or very few or no accidents and/or driving violations within a predefined period of time, e.g., 7 years.

In some embodiments, experience, inexperience, status, or competency levels could be indicated by level designations, e.g., level I could be for an inexperienced or novice driver, level II for a proficient driver, and level III for an advanced driver. In some embodiments, experience, inexperience, status, or competency levels could be indicated by colors, e.g., yellow or orange for an inexperienced driver, green for a proficient driver, and blue for an advanced driver.

In the embodiments of FIGS. 2A-D through 14A-D, color coding could be used. For example, the Learner's Permit decal could be yellow, and the Junior Operator or Beginner Driver decal could be orange. Various color coding schemes or themes could be used to distinguish among different driver level indicators.

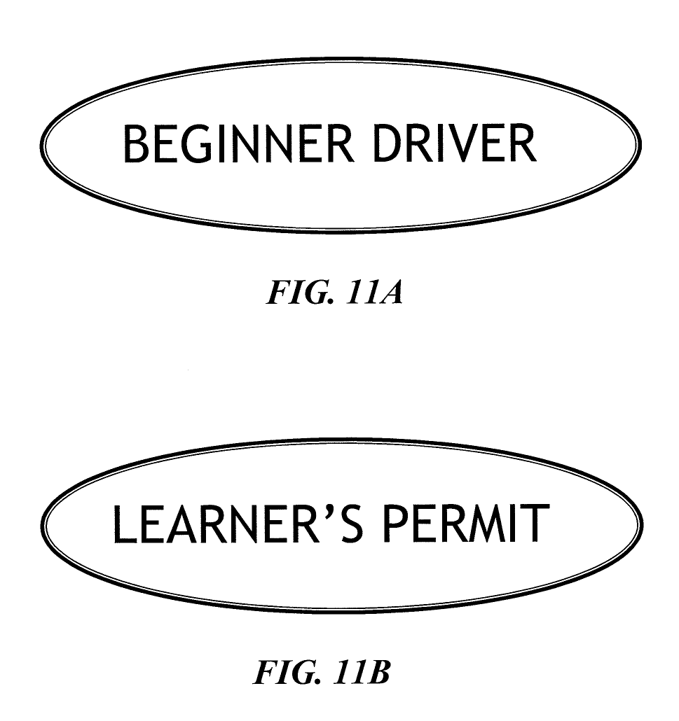

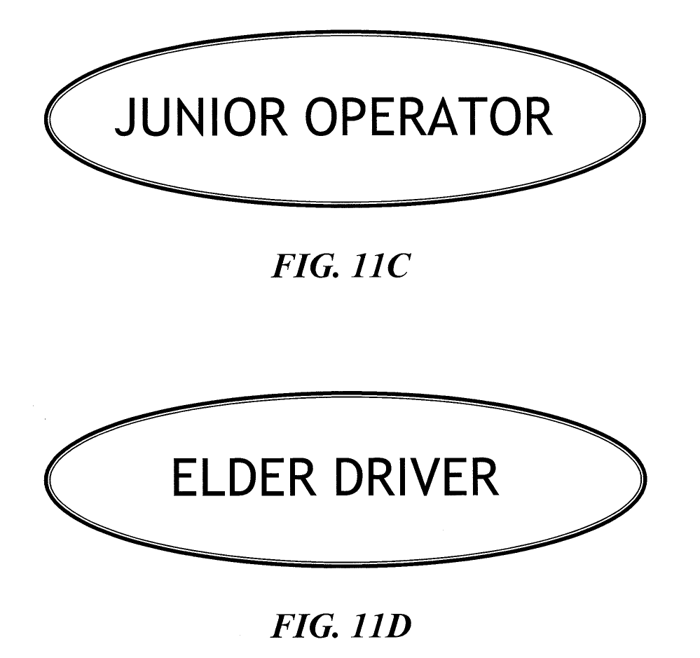

FIGS. 2A-D through 5A-D show different embodiments of different driver level indicators. And FIGS. 11A-D through 13A-D provide still other embodiments of driver level indicators. But these embodiments should not be considered to be exhaustive.

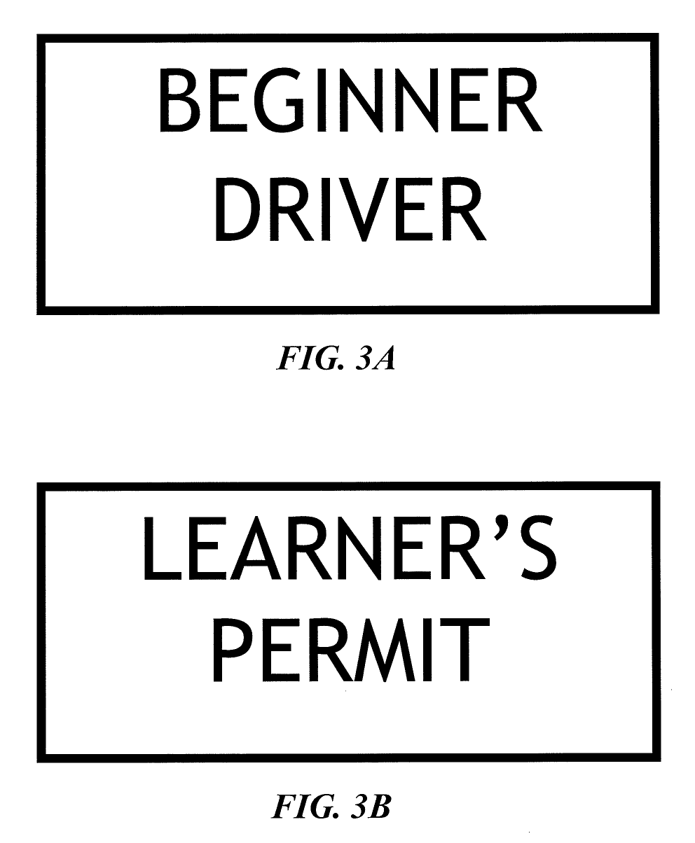

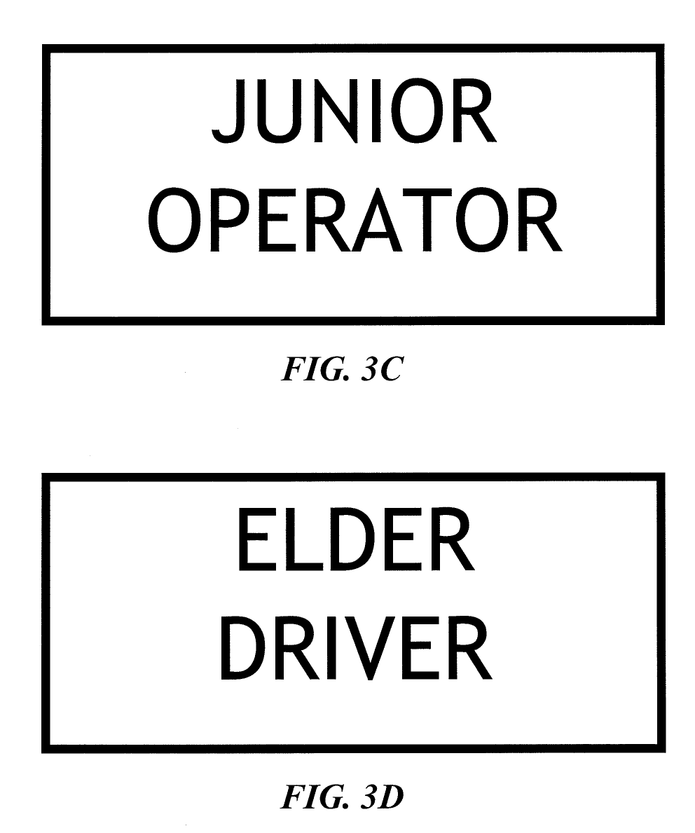

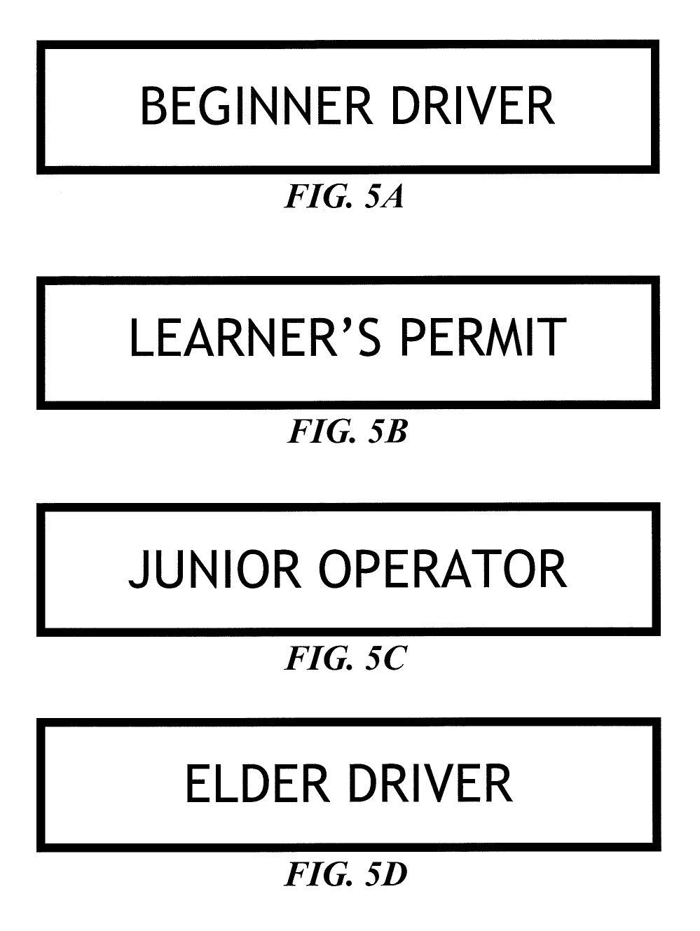

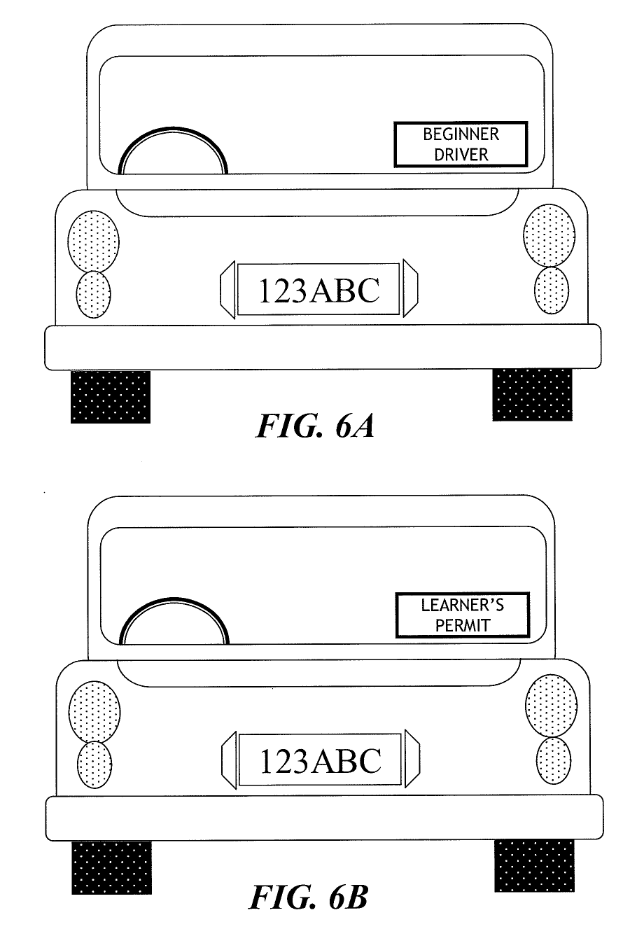

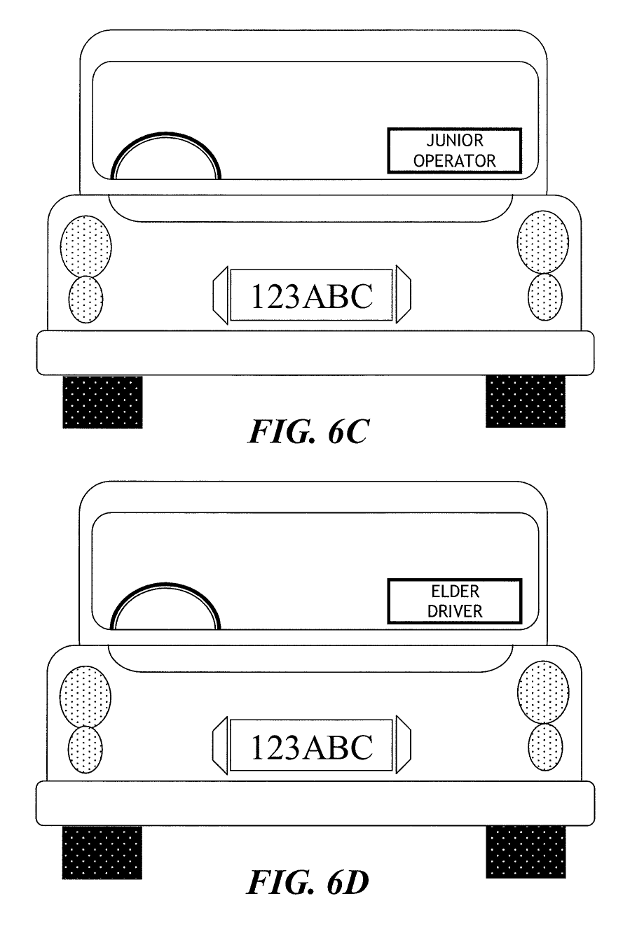

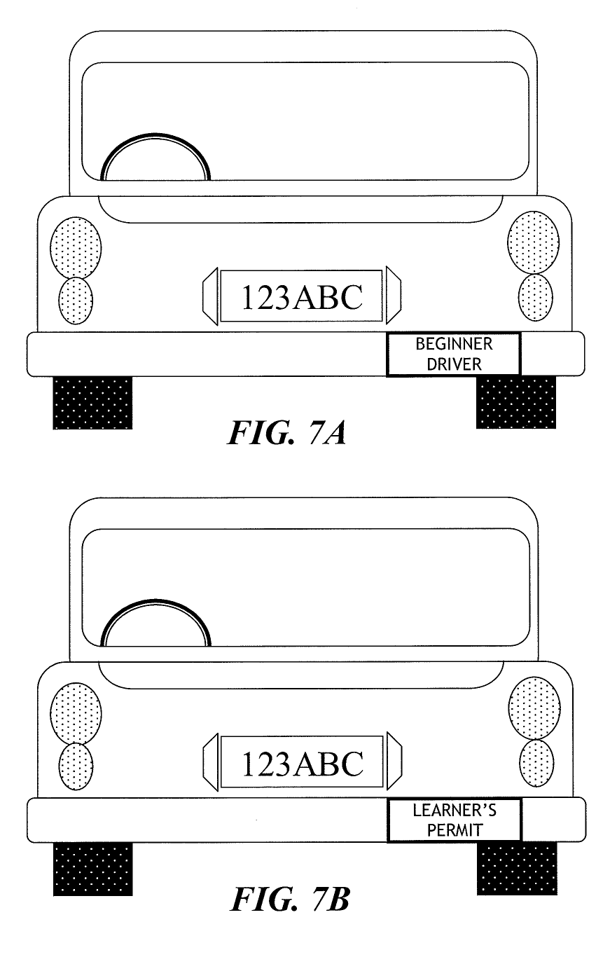

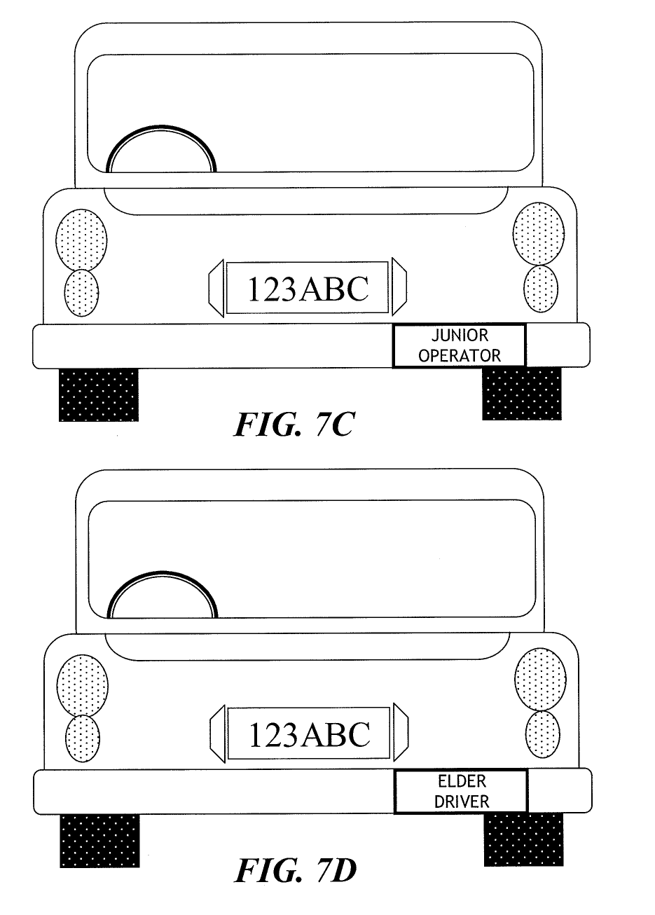

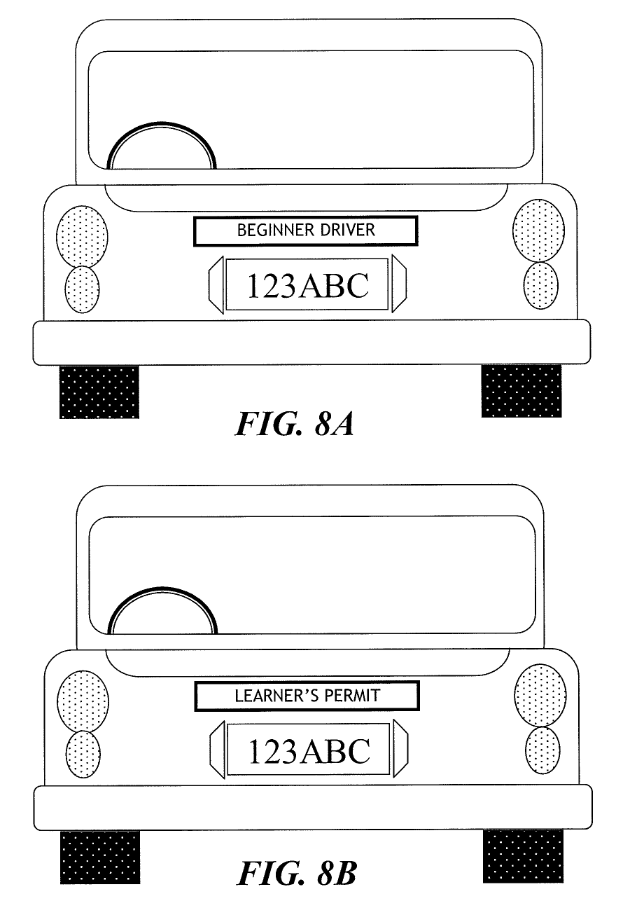

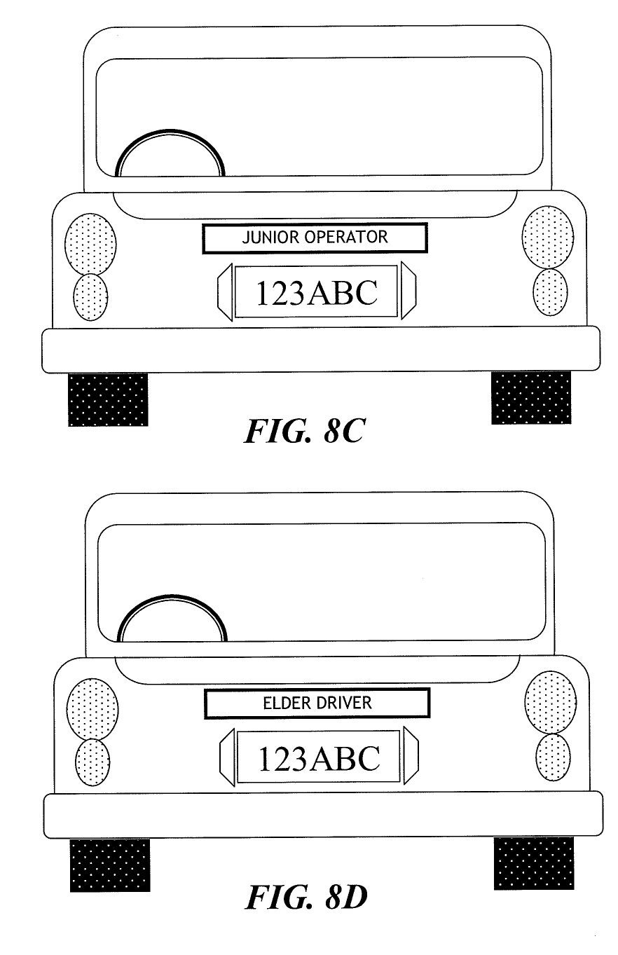

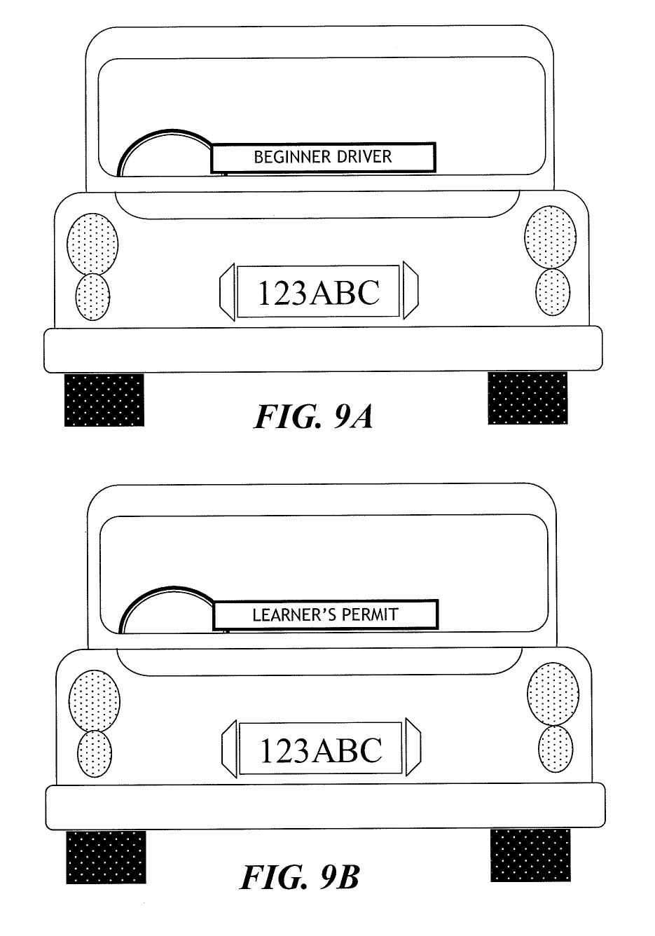

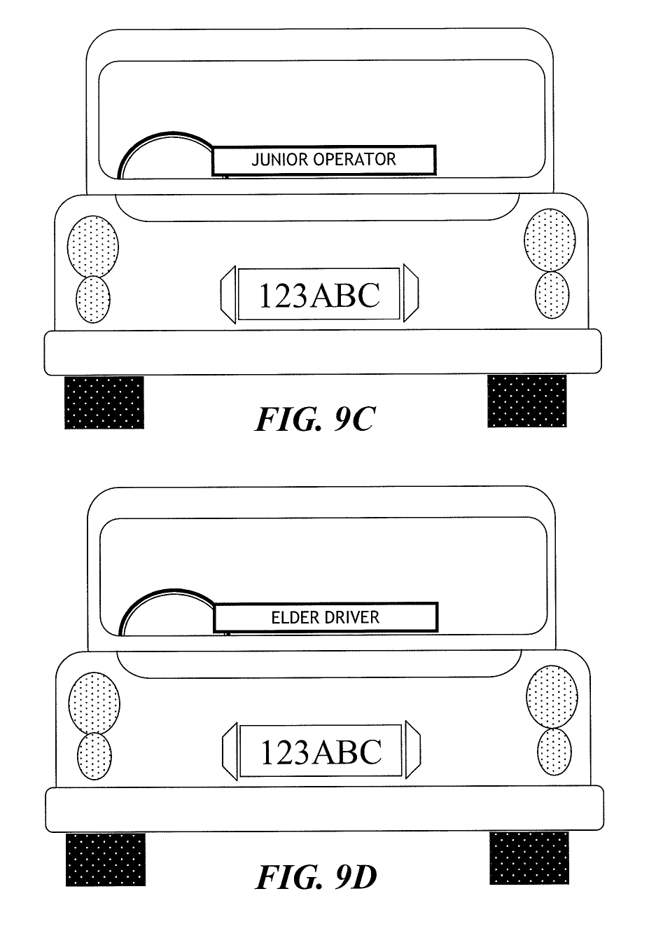

FIGS. 6A-D are embodiments where a driver level indicator as shown in FIGS. 3A-D is attached to or viewable from a rear window of a car. FIGS. 7A-D are embodiments where a driver level indicator as shown in FIGS. 3A-D is attached to a bumper of a car. FIGS. 8A-D are embodiments where a driver level indicator as shown in FIGS. 5A-D is attached to a portion of the body of a car. FIGS. 9A-D are embodiments where a driver level indicator as shown in FIGS. 5A-D is attached to or viewable from a rear window of a car. FIGS. 10A-D are embodiments where a driver level indicator as shown in FIGS. 5A-D is attached to a portion of a license plate.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A computer-implemented method of indicating a driver level at a vehicle, the computer including one or more processors coupled to at least one non-transitory computer storage medium, the method comprising the computer:
establishing at least one set of driver level criteria;
storing driver data for a driver; and
determining if the driver data satisfies a set of driver level criteria, and, if so, issuing a driver level indicator corresponding to the satisfied set of driver level criteria.

2. The method of claim 1, wherein issuing a driver level indicator includes generating an electronic or paper output authorizing issuance of the driver level indicator to the driver.

3. The method of claim 1, further comprising coupling the driver level indicator to a vehicle to be operated by the driver.

4. The method of claim 1, wherein the driver level indicator is removably attachable to the vehicle.

5. The method of claim 1, wherein the driver level indicator is irremovably attachable to the vehicle.

6. The method of claim 1, wherein the set of driver level criteria can include a driver age.

7. The method of claim 1, wherein the set of driver level criteria can include a driver experience level.

8. The method of claim 1, wherein the set of driver level criteria can include a driver safety level.

9. The method of claim 1, wherein the set of driver level criteria indicates that the driver has a learner's permit.

10. The method of claim 1, wherein the set of driver level criteria indicates that the driver has a junior operator license.

11. The method of claim 1, wherein the set of driver level criteria indicates that the driver is a beginner driver.

12. The method of claim 1, wherein the set of driver level criteria indicates that the driver is an elder driver.

13. A driver level indicator configured to couple to a vehicle, comprising:
a substrate including a driver level for a driver, wherein the driver level is based on satisfaction of a set of predefined driver level criteria by driver data of the driver; and
an attachment mechanism configured to attach the substrate to a vehicle in a manner that the driver level is viewable by other drivers.

14. The driver level indicator of claim 13, wherein the driver level indicates a safety level of the driver.

15. The driver level indicator of claim 13, wherein the driver level indicates an experience level of the driver.

16. The driver level indicator of claim 15, wherein the driver level indicates that the driver has a learner's permit.

17. The driver level indicator of claim 16, wherein the driver level indicator includes the text “Learner's Permit.”

18. The driver level indicator of claim 15, wherein the driver level indicates that the driver is a beginner driver.

19. The driver level indicator of claim 18, wherein the driver level indicator includes the text “Beginner” or “Beginner Driver.”

20. The driver level indicator of claim 15, wherein the driver level indicates that the driver has a junior operator license.

21. The driver level indicator of claim 20, wherein the driver level indicator includes the text “Junior Operator.”

22. The driver level indicator of claim 13, wherein the driver level indicates an age of the driver.

23. The driver level indicator of claim 22, wherein the driver level indicator includes the text “Elder Driver” or “Elder Operator.”

24. The driver level indicator of claim 13, wherein the driver level indicator is a decal and the attaching mechanism is an adhesive.

25. The driver level indicator of claim 13, wherein the attaching mechanism is magnet.

26. The driver level indicator of claim 13, wherein the substrate includes a display.

27. The driver level indicator of claim 13, wherein the substrate includes a license plate, license plate appendage, or license plate frame.

28. The driver level indicator of claim 13, wherein the attaching mechanism removably attaches the substrate to the vehicle.

29. The driver level indicator of claim 13, wherein the substrate includes a plurality of colors.

30. A plurality of driver level indicators, each configured to couple to a vehicle and comprising:
a substrate including a driver level for a driver, wherein the driver level is based on satisfaction of a set of predefined driver level criteria by driver data of the driver; and
an attachment mechanism configured to attach the substrate to a vehicle in a manner that the driver level is viewable by other drivers,
wherein each driver level indicator corresponds to a different set of driver level criteria and has a different visual appearance.
